(19) United States
(12) Patent Application Publication
(10) Pub. No.: US 2008/0166075 A1
(43) Pub. Date: Jul. 10, 2008

(54) Dust proof assembly of a five communicated tube

(76) Inventor: Chiung-Ling Chang, Taichung (TW)

Correspondence Address: CHIUNG-LING CHANG, 235 Chung-Ho, Box 8-24, Taipei, omitted

(21) Appl. No.: 11/649,116

(22) Filed: Jan. 4, 2007

(51) Int. Cl. F16C 33/74

(52) U.S. Cl. 384/94

(57) ABSTRACT

A dust proof assembly of a five communicated tube comprises a bearing; an inner edge of the bearing having an annular recess; a cover being a hollow annular ring; the cover having a buckle corresponding to the annular recess. By above mentioned components, the cover is buckled to the bearing; the buckle of the cover is buckled to the annular recess of the bearing. A seat has a receiving portion; a lower end of the seat being formed with a threaded portion. The bearing and cover is received in the receiving portion of the seat. The cover is a hollow annular ring. The receiving portion has a stepped structure.

### FIELD OF THE INVENTION

The present invention relates to five communicated tubes, and particularly to a dust proof assembly of a five communicated tube which has a firm structure and less material is required so that the cost is saved.

### BACKGROUND OF THE INVENTION

In the current bearing device of a five communicating tube of a bicycle, a cover encloses the bearing completely. The cover is not engaged to the bearing. Thus after dramatic vibration, the structure will become loose. Furthermore the cover encloses the bearing completely, and thus more material is required for the cover and the cost is increased. Thus it is necessary to improve the prior art structure.

### SUMMARY OF THE INVENTION

Accordingly, the primary object of the present invention is to provide a dust proof assembly of a five communicated tube which has a firm structure and less material is required so that the cost is saved.

To achieve above objects, the present invention provides a dust proof assembly of a five communicated tube which comprises a bearing; an inner edge of the bearing having an annular recess; a cover being a hollow annular ring; the cover having a buckle corresponding to the annular recess. By above mentioned components, the cover is buckled to the bearing; the buckle of the cover is buckled to the annular recess of the bearing. A seat has a receiving portion; a lower end of the seat being formed with a threaded portion; the bearing and cover is received in the receiving portion of the seat. The cover is a hollow annular ring. The receiving portion has a stepped structure.

The various objects and advantages of the present invention will be more readily understood from the following detailed description when read in conjunction with the appended drawing.

### BRIEF DESCRIPTION OF THE DRAWINGS

FIG. 1 is an exploded perspective view of the dust proof assembly of a five communicated tube of the present invention.

FIG. 2 is an assembled perspective view of the dust proof assembly of a five communicated tube of the present invention.

FIG. 3 is a lateral cross sectional view of the dust proof assembly of a five communicated tube of the present invention.

FIG. 4 is a cross sectional view about the dust proof assembly of a five communicated tube of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

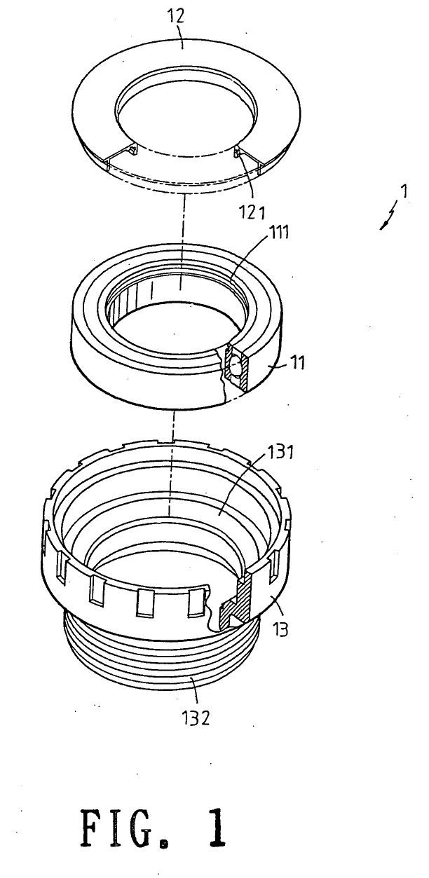

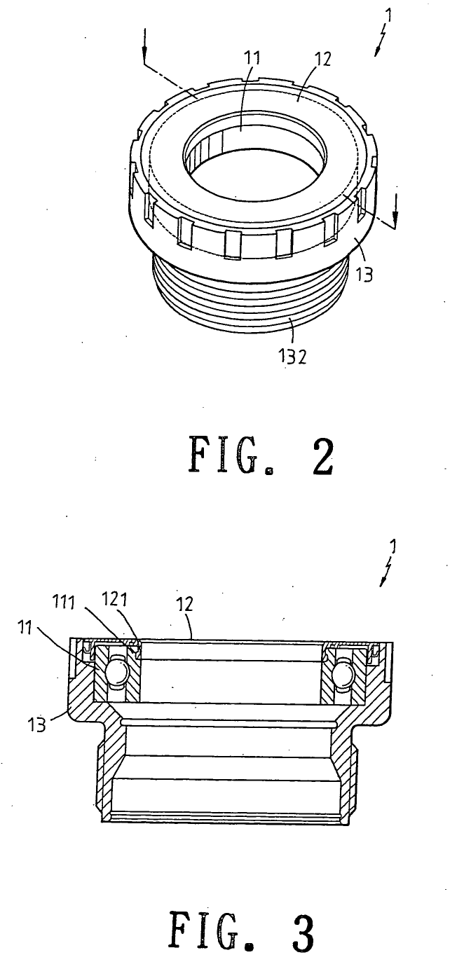

Referring to FIGS. 1 to 3, the dust proof assembly of a five communicated tube of the present invention is illustrated. The present invention has the following elements.

The body 1 has a bearing 11 and a cover 12.

An inner edge of the bearing 11 has an annular recess 111.

The cover 12 is a hollow annular ring. The cover 12 has a buckle 121 corresponding to the annular recess 111.

A seat 13 has a stepped receiving portion 131. A lower end of the seat 13 is formed with a threaded portion 132.

By above mentioned structure, the cover 12 can be buckled to the bearing 11. The buckle 121 of the cover 12 is buckled to the annular recess 111 of the bearing 11. Then they are received in the receiving portion 131 of the seat 13.

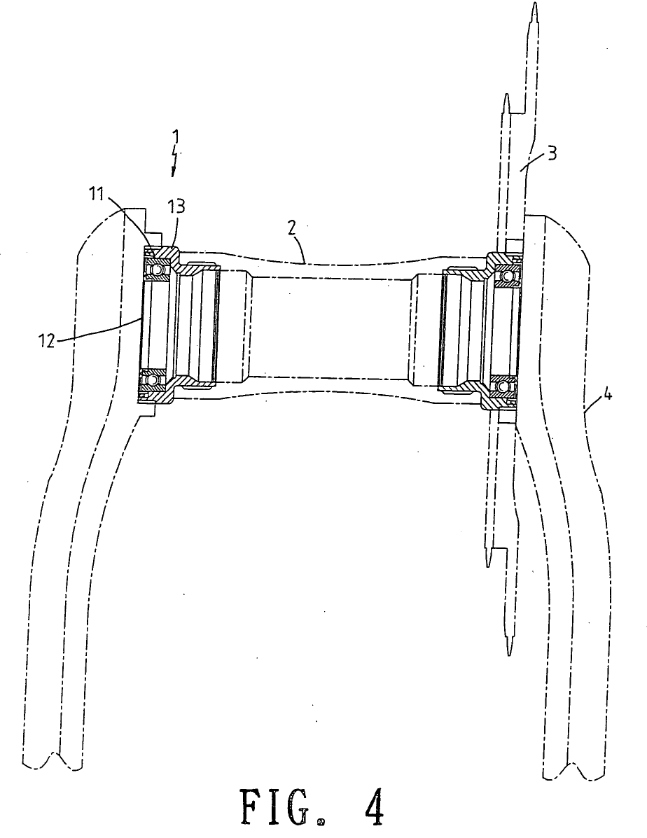

Referring to FIG. 4, the assembly of the present invention is illustrated. Two bodies 1 are connected to two ends of the connecting tube 2 by the threaded portions 132 thereof. A gear 3 encloses one of the bodies 1. Then the assembly structure is installed to a car body 4. Because the cover 12 is buckled to the bearing 11 and the buckle 121 is tightly engaged to the annular recess 111, after the buckle 121 is buckled to the annular recess 111, the cover 12 will not release from the bearing 11 even suffering from dramatic vibration. Thus the structure strength is enhanced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A dust proof assembly of a five communicated tube comprising:
a bearing; an inner edge of the bearing having an annular recess;
a cover being a hollow annular ring; the cover having a buckle corresponding to the annular recess;
wherein by above mentioned components, the cover is buckled to the bearing; the buckle of the cover is buckled to the annular recess of the bearing.

2. The dust proof assembly of a five communicated tube as claimed in claim 1, further comprising a seat having a receiving portion; a lower end of the seat being formed with a threaded portion; the bearing and cover being received in the receiving portion of the seat.

3. The dust proof assembly of a five communicated tube as claimed in claim 2, wherein the cover is a hollow annular ring.

4. The dust proof assembly of a five communicated tube as claimed in claim 2, wherein the receiving portion has a stepped structure.
